(19) United States
(12) Patent Application Publication
(10) Pub. No.: US 2013/0055568 A1
(43) Pub. Date: Mar. 7, 2013

(54) METHOD AND DEVICE FOR PRODUCING A COMPONENT

(71) Applicants: Karl-Heinz Dusel, Unterschleissheim (DE); Roland Huttner, Jesenwag (DE); Erwin Bayer, Dachau (DE); Michael Muecke, Woellstadt (DE)

(72) Inventors: Karl-Heinz Dusel, Unterschleissheim (DE); Roland Huttner, Jesenwag (DE); Erwin Bayer, Dachau (DE); Michael Muecke, Woellstadt (DE)

(73) Assignees: Global Beam Technologies AG, Maisach (DE); MTU Aero Engines GmbH, Muenchen (DE)

(21) Appl. No.: 13/583,411

(22) PCT Filed: Mar. 7, 2011
(86) PCT No.: PCT/EP2011/053382

§ 371 Date: Nov. 15, 2012

(30) Foreign Application Priority Data
Mar. 11, 2010 (DE) 10 2010 011 059.0

(51) Int. Cl. B05D 3/06; B23P 17/00; B05C 11/00; B23K 37/00

(52) U.S. Cl. 29/888.02; 29/407.01; 427/551; 118/641

(57) ABSTRACT

A method for manufacturing a component, in particular a component of a turbine or a compressor, in which at least these steps are carried out: application in layers of at least one powdered component material to a component platform in the area of a buildup and joining zone; melting and/or sintering locally in layers of the component material by supplying energy with the aid of at least one electron beam in the area of the buildup and joining zone; lowering of the component platform in layers by a predefined layer thickness; and repeating steps a) through c) until completion of the component. During the manufacturing, electrons emitted due to the interaction of the electron beam with the component material are detected, after which material information, characterizing the topography of the melted and/or sintered component material, is ascertained on the basis of the emitted electrons. Alternatively or additionally, the component material is melted and/or sintered by at least two, preferably at least four electron beams.

The present invention relates to methods for manufacturing a component. The present invention also relates to devices for manufacturing a component, in particular a component of a turbine or a compressor.

### BACKGROUND

A wide variety of methods and devices for manufacturing a component are known. In particular, generative fabrication methods (so-called rapid manufacturing and/or rapid prototyping methods) are known, in which the component is built up in layers. In the present case, metal components can be manufactured by electron beam melting or sintering methods. In such a method, at least one powdered component material is initially applied in layers to a component platform in the area of a buildup and joining zone. Next the component material is melted and/or sintered locally in layers by supplying energy with the aid of at least one electron beam to the component material in the area of the buildup and joining zone. The electron beam is controlled as a function of layer information from the particular component layer to be manufactured. After melting and/or sintering, the component platform is lowered in layers by a predefined layer thickness. These steps are then repeated until the final completion of the component.

One disadvantage of methods and devices currently known is that they allow either comparatively low buildup rates at elevated levels of fabrication precision or they allow higher buildup rates with comparatively low fabrication precision. This results in long production times and associated high manufacturing costs in the fabrication of components for turbomachines, in particular for hollow structural components for turbines or compressors.

### SUMMARY OF THE INVENTION

It is an object of the present invention is to create a method and a device of the type specified at the outset for manufacturing a component, to permit a high buildup rate as well as high fabrication precision.

The present invention provides a method for manufacturing a component, in particular a component of a turbine or a compressor, it is provided that electrons emitted due to interaction of the electron beam with the component material are detected, after which material information characterizing the topography of the melted and/or sintered component material is ascertained on the basis of the emitted electrons. The method according to the present invention, in contrast with the related art, thus makes it possible to control the fabrication precision during the manufacture of the component with the aid of a scanning electron microscope-type surface analysis of the instantaneous component layer. Since electrons have a much shorter wavelength than visible light, the topography may be ascertained with very high resolution by using the electron beam which is present anyway. Preferably secondary electrons, backscattered electrons and/or Auger electrons are detected as emitted electrons by an appropriate detection device and used for ascertaining the material information characterizing the topography. The material information may be ascertained by an ascertaining device, for example, connected to the detection device. Knowledge of the topographic material information subsequently permits an immediate correction or adjustment in the energy supplied by the electron beam, so that the buildup time required to manufacture the component is greatly shortened and high buildup rates as well as high fabrication precision are achieved. Furthermore, in many cases it is possible to omit any reworking steps, which results in additional time and cost savings. It should be emphasized that in addition to components for turbomachines, basically any component may be manufactured with the aid of the method according to the present invention.

In an advantageous embodiment of the present invention, it is provided that the electrons are detected once and/or in the case of multiple repetitions of steps a) through c) and/or with each repetition of steps a) through c). In this way, the method may be carried out in a particularly flexible and time-optimized manner because the topography of the particular component layer is preferably ascertained only when it is a component layer which is relevant for the fabrication precision.

In another advantageous embodiment of the present invention, it is provided that in step b) a spatial deflection and/or focusing and/or thermal power of the at least one electron beam is set as a function of layer information about the component to be manufactured and/or as a function of the material information. In this way, the component can be manufactured very rapidly and with a high precision at the same time. For example, a larger focal spot and/or a high power of the electron beam may be set in component areas having a greater wall thickness. On the other hand, in component areas having a small or filigree wall thickness, it is possible to set a low power and/or a smaller focal spot of the electron beam. Since there is also the possibility of direct monitoring of the resulting topography through detection of the emitted electrons at the same time, the spatial deflection and focusing of the electron beam can be controlled as a function of the situation and in synchronization with the power. For example, if an excessive deviation between a setpoint topography and an actual topography ascertained for the component layer is detected, the spatial deflection, the focus and/or the thermal power of the electron beam can be directly changed and adjusted. Any distortion or other deviations in the actual geometry of the component from the setpoint geometry of the component can thus be prevented reliably in manufacturing the component. The electron beam is preferably adjusted with the aid of a digital control and/or regulating unit, a deflection amplifier or the like to ensure rapid and precise adjustment to the properties of the corresponding component layer. It is basically provided here that the electron beam is deflected into two or more different positions so rapidly that the component material is melted or sintered more or less “simultaneously” in all these positions. If necessary, the electron beam may be split into multiple partial beams for this purpose. In addition, it is possible to provide that the electron beam is repeatedly deflected to these different positions, so that the melting or sintering process is maintained at least essentially continuously in the respective positions for a desired period of time.

Additional advantages are obtained by adjusting the spatial deflection and/or the focus and/or the thermal power of the at least one electron beam by at least one electromagnetic and/or magnetic field. In this way, the electron beam can be adjusted in a particularly rapid, simple and variable manner by varying the electromagnetic and/or magnetic field, so that a particularly high buildup rate and fabrication precision are achieved in the manufacture of the component.

Additional advantages are achieved due to the fact that the component material in step b) is melted and/or sintered by at least two, preferably by at least four electron beams. In this way, multiple melting and/or sintering areas can be created at the same time, so that a significant acceleration of the buildup rate is achieved with greater dimensional accuracy. In addition, this eliminates the previous installation space restriction of electron melting methods, so that even large components can be manufactured with no problem. The two or more electron beams can be generated basically by splitting one electron beam and/or by using multiple electron sources. Splitting of the electron beam may be done in parallel or sequentially. Sequential splitting is preferably used. In sequential splitting this takes place so quickly that multiple beams are formed macroscopically. The split beam may be deflected sequentially to different locations. In this way, sintering or melting may take place at the same time at different locations. The material-dependent time constant for sintering is preferably much larger than the time constant for beam splitting. The electron beams can be controlled in step b) without inertia in three dimensions in the deflection and in the energy level, so that it is possible to manufacture components of any size and also components of particular complexity. The buildup and joining zone may also be expanded almost without limitation due to the additional electron sources, so that the method can be parallelized and is easily scalable. It is basically possible for the electron beams to be deflected to two or more different positions so rapidly that the component material is melted or sintered more or less “simultaneously” in all these positions. Furthermore, it is possible to provide that at least one of the electron beams is split into two or more partial beams. In addition, it is possible to provide for the electron beams to be deflected repeatedly to these different positions, so that the melting or sintering process is not terminated at the respective positions and instead is maintained continuously.

In another advantageous embodiment of the present invention, it is provided that a relative position of at least one electron source, which is used for manufacturing at least one electron beam, is adjusted with respect to the buildup and joining zone as a function of the layer information of the component to be manufactured and/or as a function of the material information. This allows a further improvement in the fabrication quality and precision, while optimally taking into account the properties of the respective component layer.

Since at least step b) is carried out in vacuo, in particular in a high vacuum, deflection of the electron beam or beams and the electrons emitted due to the interaction of the electron beam(s) with the component material is reliably prevented. Both the fabrication rate and precision and the precision of the topography determination of the measured component layer are increased in this way. Furthermore, the component is manufactured in a practically oxygen-free atmosphere, so that the component can also be fabricated from high-purity or oxygen-sensitive component materials.

To ensure a particularly high fabrication precision, in another embodiment of the present invention, it is provided that surface machining of the component, in particular fine machining, is carried out after it has been manufactured. In this way, the high quality demands of engine components for turbines or compressors, for example, can be met reliably.

In another advantageous embodiment of the present invention, it is provided that a component surface of the component is machined by at least one electron beam, in particular by electron beam lithography and/or remelting. In this way, the component surface can be smoothed or provided with a predetermined surface structure. Basically the electron beam can be generated using the same electron source which has already been used for melting and/or sintering of the component material. Alternatively or additionally, a separate electron source may of course also be provided for the fine machining.

Additional advantages are derived if the electrons emitted due to the interaction of the electron beam with the component surface during machining of the component are detected, after which component information characterizing the topography of the component is ascertained on the basis of the emitted electrons. In this way, the advantages explained above with regard to direct quality monitoring of the instantaneous manufacturing step in conjunction with manufacturing the component can also be achieved during fine machining. It is preferably provided that the detection device described above is also used for detecting the emitted electrons during the fine machining step. The component information can be ascertained by the ascertaining device, for example, which is connected to the detection device.

In another advantageous embodiment of the present invention, it is provided that a spatial deflection and/or focusing and/or thermal power of the at least one electron beam is adjusted as a function of the component information. In this way, particularly high fabrication precision is again achieved during fine machining of the component surface.

Another aspect of the present invention relates to a device for manufacturing a component, in particular a component of a turbine or a compressor, the device including at least one powder feed for application of at least one powdered component material to a component platform and at least one electron source with the aid of which at least one electron beam can be generated for melting and/or sintering locally in layers of the component material in the area of the buildup and joining zone of the component platform. According to the present invention, an increased buildup rate of the component is made possible with an increased fabrication precision at the same time due to the fact that the device includes at least one detection device for detecting electrons emitted due to the interaction of the electron beam with the component material and an ascertaining device, which is connected to the detection device and makes it possible to ascertain material information characterizing the topography of the melted and/or sintered component material on the basis of control information from the detection device characterizing the detected electrons. The device according to the present invention, in contrast to the related art, thus allows precise control during the manufacture of the component with the aid of a scanning electron microscope-type surface analysis. Since electrons have a much shorter wavelength than visible light, the topography can be ascertained with very high resolution by using the electron beam which is present anyway. Secondary electrons, backscattered electrons and/or Auger electrons are preferably detected by the detection device as the emitted electrons and are transmitted as control information to the ascertaining device for ascertaining the material information characterizing the topography. Knowledge of the topographic material information subsequently permits an immediate correction or adjustment of the energy supplied with the aid of the electron beam, so that the buildup time required for manufacturing the component can be shortened greatly while maintaining high fabrication precision at the same time. Furthermore, it is possible in many cases to omit any reworking steps, which results in additional time and cost savings. The preferred embodiments and refinements and their advantages presented above in conjunction with the method according to the present invention are applicable accordingly for the device according to the present invention and vice-versa. It must be emphasized that basically other components can be manufactured with the help of the device according to the present invention instead of components for turbomachines.

In one advantageous embodiment of the present invention, it is provided that the ascertaining device is connected to a control and/or regulating device, the control and/or regulating device being designed to operate the electron source as a function of layer information about the component to be manufactured and/or as a function of the material information. In this way, particularly high fabrication precision is ensured, while minimizing the manufacturing time for the component.

Additional advantages are derived when the device includes means for generating at least two, preferably at least four electron beams. This allows a substantial increase in the manufacturing rate while at the same time achieving high dimensional accuracy. Additional advantages that are achieved can be derived from the preceding descriptions.

Another aspect of the present invention relates to an alternative method for manufacturing a component, in particular a component of a turbine or a compressor. It is provided according to the present invention that the component material in step b) is melted and/or sintered by at least two, preferably by at least four electron beams. With the aid of two or more electron beams, an increased buildup rate is made possible with increased fabrication precision at the same time, in contrast to the related art, since multiple melting and/or sintering areas are created at the same time. Furthermore, this eliminates the previous installation space restrictions, so that even large components can be manufactured with no problem. The two or more electron beams can basically be generated by splitting one electron beam and/or by using multiple electron sources. The electron beams can be controlled in step b) without inertia in three dimensions in the deflection and in the energy level so that it is possible to manufacture components of any desired size and also components of particular complexity. By using additional electron sources, the buildup and joining zone can also be expanded to an almost unlimited extent, so the method can be parallelized and is also easily scalable. The preferred embodiments and refinements and their advantages, which were presented above in conjunction with the first method according to the present invention and the first device according to the present invention, are also applicable accordingly for this method according to the present invention and vice-versa.

In an advantageous embodiment of the present invention, it is provided that the electron beams are generated by splitting one electron beam of an electron source and/or by using multiple electron sources. In this way, the electron beams can be generated and aligned in a flexible manner and as a function of the component to be manufactured.

In another advantageous embodiment of the present invention, it is provided that electrons emitted due to interaction of the electron beam with the component material are detected, after which material information characterizing the topography of the melted and/or sintered component material is ascertained on the basis of the emitted electrons. In this way, with the aid of the scanning electron microscope-type analysis of the topography of the component manufactured at that moment, direct control of the manufacturing process can be implemented. The resulting features and their advantages can be derived from the preceding descriptions.

Another aspect of the present invention relates to a device for manufacturing a component, in particular a component of a turbine or a compressor, having at least one powder feed for applying at least one powdered component material to a component platform and also having at least one electron source with the aid of which at least one electron beam can be generated for melting and/or sintering locally in layers of the component material in the area of a buildup and joining zone of the component platform. According to the present invention, an increased buildup rate is made possible with increased fabrication precision at the same time due to the fact that the device includes means for generating at least two, preferably at least four electron beams. With the aid of two or more electron beams, an increased buildup rate is made possible with increased fabrication precision at the same time, in contrast to the related art, since multiple melting and/or sintering areas can be created at the same time. In addition, the previous installation space restriction is omitted so that even large components can be manufactured with no problem. The two or more electron beams can basically be generated by splitting one electron beam and/or by using multiple electron sources. The electron beams can be controlled without inertia in three dimensions in the deflection and in the energy level, so it is possible to not only manufacture components of any desired size but also components of particular complexity. The buildup and joining zone can also be expanded to an almost unlimited extent through additional electron sources, so that the device is parallelizable and easily scalable. The preferred embodiment presented in conjunction with the method according to the present invention and the first device according to the present invention and their advantages apply accordingly to this device according to the present invention and vice-versa.

Additional advantages are obtained in that the means for generating the at least two electron beams include a device for splitting one electron beam of one electron source and/or multiple electron sources. The electron beams can be generated and aligned in a flexible manner in this way, depending on the component to be manufactured.

In a further advantageous embodiment of the present invention, it is provided that the device includes at least one detection unit for detecting electrons emitted due to the interaction of the electron beam with the component material as well as an ascertaining unit connected to the detection unit, with the aid of which the material information characterizing the topography of the melted and/or sintered component material can be ascertained on the basis of control information of the detection unit characterizing the electrons thus detected. In this way, direct control of the manufacturing process is possible with the aid of a scanning electron microscope-type analysis of the topography of the component being manufactured at that moment. The resulting features and their advantages can be derived from the preceding descriptions.

### BRIEF DESCRIPTION OF THE DRAWINGS

Additional features of the present invention are derived from the claims, the exemplary embodiments and on the basis of the drawings. The features and combinations of features mentioned in the description above as well as the features and combinations of features mentioned in the exemplary embodiments below may be used not only in the particular combination indicated but also in other combinations or alone without departing from the scope of the present invention.

FIG. 1 shows a schematic diagram of a first exemplary embodiment of a device according to the present invention for manufacturing a component, and

FIG. 2 shows a schematic diagram of a second exemplary embodiment of the device according to the present invention for manufacturing a component.

### DETAILED DESCRIPTION

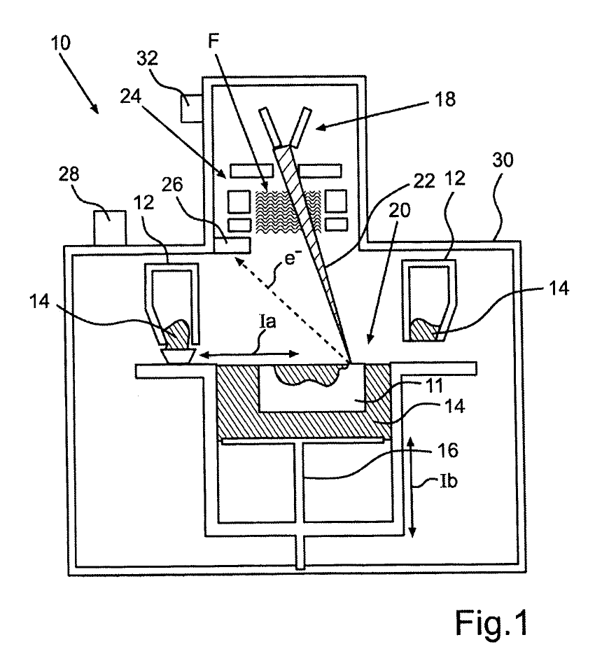

FIG. 1 shows a schematic diagram of a first exemplary embodiment of a device 10 according to the present invention for manufacturing a component 11, which in the present case is provided for use in a turbomachine. The same elements or those having the same function are provided with identical reference numerals below. Component 11 in the exemplary embodiment shown here is a hollow structural component of a turbine. Device 10 includes a powder feed 12 movable according to double arrow Ia for application of at least one powdered component material 14 to a component platform 16 movable according to double arrow Ib. In addition, device 10 includes two electron sources 18 with the aid of which electron beams 22 are generated for melting and/or sintering locally in layers of component material 14 in the area of a buildup and joining zone 20 of component platform 16. For adjusting the spatial deflection, the focus and the thermal power of electron beams 22, device 10 additionally includes a unit 24 for generating electromagnetic fields F. Electron beams 22 of electron sources 18—as shown in the present case—may be combined to form one beam, separated from one another or split into multiple electron beams 22 with the aid of unit 24.

Device 10 has a detection unit 26 for detecting electrons e⁻ emitted due to the interaction of electron beams 22 with component material 14 and also has an ascertaining unit 28, which is connected to detection unit 26 for the purpose of controlling the manufacturing process. The links between the individual units of device 10 are not shown here and will not be discussed below for reasons of simplicity. Detected electrons e⁻ are preferably secondary electrons, backscattered electrons and/or Auger electrons. Material information characterizing the topography of the melted and/or sintered component material 14 can be ascertained with the aid of ascertaining unit 28 on the basis of control information from detection unit 26 characterizing the detected electrons e⁻. In other words, measurement of the surface and the surface properties of component 11 may take place during the machining operation. It is basically possible to provide for electron beam 22 to be deflected into two or more different positions so rapidly that component material 14 is melted and/or sintered more or less “simultaneously” in all these positions. If necessary, electron beam 22 may be split into multiple partial beams for this purpose, as described above. In addition, it is possible to provide for electron beam 22 to be repeatedly deflected to these different positions, so that the melting or sintering process is maintained as continuously as possible at the corresponding positions for a desired period of time.

To be able to manufacture component 11 in the absence of oxygen and to avoid undesirable deflection of electron beams 22 as well as electrons e⁻, device 10 includes a vacuum chamber 30 in which a high vacuum is generated during the manufacture of component 11.

To adjust electron beams 22, electron sources 18, unit 24 and ascertaining unit 28 are connected to a digital control and/or regulating unit 32, which is designed to trigger electron sources 18 as a function of layer information of component 11 to be manufactured and/or as a function of the ascertained material information. Control and/or regulating unit 32 thus allows a rapid and precise adjustment of electrons beams 22 to the properties of the respective component layer. In addition, control and/or regulating unit 32 is capable of controlling electron sources 18 in such a way that electron beams 22 sequentially approach multiple melting points and/or sintering points on the buildup and joining zone 20 in an extremely short sequence. The deflection and focusing of electron beams 22 may be controlled spatially in synchronization with the power. At the same time, “online monitoring” of the manufacturing process is available through detection and analysis of emitted electrons e⁻. The use of multiple electron beams 22 and the possibility of direct control of the melting and/or sintering operation permit a high manufacturing rate with high fabrication precision at the same time. Furthermore, there is no longer any restriction on the installation space due to the two or more electron sources 18 because electron sources 18 can be arranged freely and optionally movably within vacuum chamber 30. The installation area of device 10 can be expanded to an almost unlimited extent through an appropriate arrangement of multiple electron sources 18.

The manufacture of component 11 is described below with reference to device 10. Powdered component material 14 is initially applied in layers to component platform 16 in the area of the buildup and joining zone 20 with the aid of powder feed 12. Alternatively, multiple different component materials 14 may also be applied, with each component layer optionally being designed to be different. Next, component material 14 is melted and/or sintered locally in layers by supplying energy with the aid of electron beams 22. The energy supplied via electron beams 22 is controlled in the manner described above as a function of layer information of component 11 and/or as a function of material information characterizing the topography of the melted and/or sintered component material 14. After melting and/or sintering, component platform 16 is lowered by a predefined layer thickness. The steps already mentioned are then repeated until component 11 is completed.

If desired, component 11 may additionally be surface-machined after it is manufactured, in particular fine machined. To do so, energy is again supplied to the component surface of component 11 with the aid of at least one electron beam 22 to create the desired surface structure. For example, the component surface may be machined in the manner of an electron beam lithography method and/or by remelting. In this process, the instantaneous surface structure of component 11 is again ascertained as in the method described above by detecting electrons e⁻ emitted due to the interaction of electron beam 22 with the component surface and subsequently ascertaining component information characterizing the topography of component 11. Spatial deflection, focusing and/or thermal power of at least one electron beam 22 can be optimized by taking this component information into account to generate the desired surface structure.

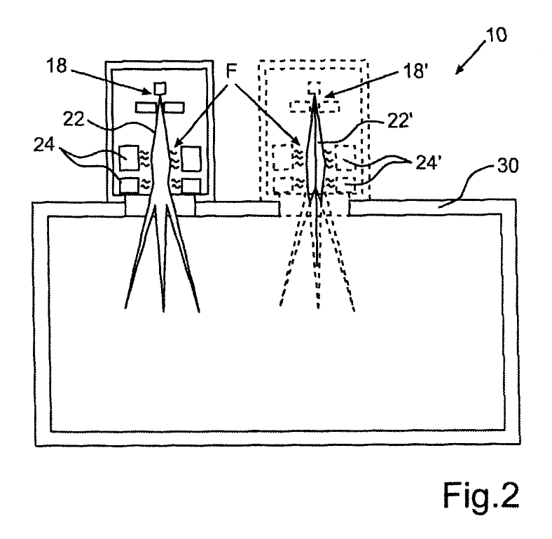

FIG. 2 shows a schematic diagram of a second exemplary embodiment of device 10 according to the present invention for manufacturing a component 11. Various elements of device 10, which are illustrated in FIG. 1 and are described in conjunction with this, are not shown in FIG. 2 for reasons of simplicity. In contrast to the preceding exemplary embodiment, device 10 shown in FIG. 2 includes two spatially separated electron sources 18, 18′ with the aid of which spatially separated electron beams 22, 22′ are generated for melting and/or sintering locally in layers of component material 14. To adjust the spatial deflection, the focus and the thermal power of electron beams 22, 22′, device 10 additionally includes the corresponding units 24, 24′ for generating electromagnetic fields F assigned to corresponding electron beam 22, 22′. With the aid of units 24, 24′, electron beams 22, 22′ of electron sources 18, 18′ may be combined into one beam or split or separated, as explained above. Electron beams 22, 22′ may also be varied independently of one another, so that the manufacturing process can be implemented in a particularly flexible manner. The splitting may take place in parallel or sequentially. In particular, multiple melting and/or sintering points can be created simultaneously on the buildup and joining zone 20 (not shown), where the deflection, the focus and the power of electron beams 22, 22′ are controllable independently of one another. It is basically possible to provide for electron beams 22, 22′ to be deflected onto two or more different positions so rapidly that component material 14 is melted or sintered more or less “simultaneously” in all these positions. In addition, it is possible to provide for at least one of electron beams 22, 22′ to be split into two or more partial beams. Furthermore, it is possible to provide for electron beams 22, 22′ to be deflected repeatedly onto these different positions, so that the melting or sintering process at the corresponding positions is not terminated and is maintained continuously. At the same time, the surface geometry or surface properties of component 11 can be measured in the manner described above. This permits a particularly high buildup rate with increased fabrication precision at the same time. Furthermore, this eliminates virtually any installation space restriction, so that even large and/or particularly complex components 11 can be manufactured with no problem. Due to additional electron sources 18, the buildup and joining zone 20 (not shown) can also be expanded to a virtually unlimited extent so that the method is easily parallelizable and easily scalable.

What is claimed is:

1-20. (canceled)

21. A method for manufacturing a component comprising the following steps:
a) applying in layers at least one powdered component material to a component platform in an area of a buildup and joining zone;
b) melting and/or sintering locally in layers of the component material by supplying energy with the aid of at least one electron beam in the area of the buildup and joining zone;
c) lowering of the component platform in layers by a predefined layer thickness; and
d) repeating steps a) through c) until completion of the component, and
detecting electrons emitted due to the interaction of the electron beam with the component material, after which material information, characterizing the topography of the melted and/or sintered component material, is ascertained on the basis of the emitted electrons.

22. The method as recited in claim 21 wherein the electrons are detected once and/or when steps a) through c) are repeated several times and/or with each repetition of steps a) through c).

23. The method as recited in clam 21 wherein a spatial deflection and/or focusing and/or thermal power of the at least one electron beam is/are adjusted in step b) as a function of layer information of the component to be manufactured and/or as a function of the material information.

24. The method as recited in claim 21 wherein the spatial deflection and/or focusing and/or thermal power of the at least one electron beam is/are adjusted by at least one electromagnetic and/or magnetic field.

25. The method as recited in claim 21 wherein the component material is melted and/or sintered in step b) by at least two electron beams.

26. The method as recited in claim 21 wherein the component material is melted and/or sintered in step b) by at least four electron beams.

27. The method as recited in claim 21 wherein a relative position of at least one electron source used to generate the at least one electron beam is adjusted with respect to the buildup and joining zone as a function of the layer information of the component to be manufactured and/or as a function of the material information.

28. The method as recited in claim 21 wherein at least step b) is performed in vacuo.

29. The method as recited in claim 21 wherein the component is surface-machined.

30. The method as recited in claim 29 wherein the component is fine machined.

31. The method as recited in claim 29 wherein a component surface of the component is machined by the at least one electron beam.

32. The method as recited in claim 31 wherein the machining is by electron beam lithography and/or remelting.

33. The method as recited in claim 31 wherein the detecting step occurs during machining of the component.

34. The method as recited in claim 33 wherein a spatial deflection and/or focusing and/or thermal power of the at least one electron beam is set as a function of the component information.

35. The method as recited in claim 21 wherein the component is a turbine or compressor component.

36. A device for manufacturing a component comprising:
at least one powder feed for application of at least one powdered component material to a component platform;
at least one electron source with the aid of which at least one electron beam is generable for melting and/or sintering locally in layers of the component material in an area of a buildup and joining zone of the component platform;
at least one detection unit for detecting electrons emitted due to the interaction of the electron beam with the component material; and
an ascertaining unit connected to the detection unit with the aid of which material information characterizing the topography of the melted and/or sintered component material is ascertainable on the basis of control information of the detection unit characterizing the detected electrons.

37. The device as recited in claim 36 further comprising a control and regulating unit connected to the ascertaining unit, the control and/or regulating unit being designed to operate the electron source as a function of layer information of the component to be manufactured and/or as a function of the material information.

38. The device as recited in claim 36 wherein the at least one electron source generates at least two electron beams.

39. The device as recited in claim 36 wherein the at least one electron source generates at least four electron beams.

40. The device as recited in claim 36 wherein the component is a turbine or compressor component.

41. A method for manufacturing a component comprising the following steps:
a) applying in layers at least one powdered component material to a component platform in an area of a buildup and joining zone;
b) melting and/or sintering locally in layers of the component material by supplying energy with the aid of at least one electron beam in the area of the buildup and joining zone;
c) lowering of the component platform in layers by a predefined layer thickness; and
d) repeating steps a) through c) until completion of the component,
the component material in step b) being melted and/or sintered by at least two of the at least one electron beam.

42. The method as recited in claim 41 wherein the component material in step b) being melted and/or sintered by at least four of the at least one electron beam

43. The method as recited in claim 41 wherein the electron beams are generated by splitting one first electron beam of an electron source and/or by using multiple electron sources.

44. The method as recited in claim 41 wherein the component is a turbine or compressor component.

45. A device for manufacturing a component comprising:
at least one powder feed for application of at least one powdered component material to a component platform;
at least one electron source with the aid of which at least two electron beams are generable for melting and/or sintering locally in layers of the component material in the area of a buildup and joining zone of the component platform.

46. The device as recited in claim 45 wherein the at least one electron source generates at least four electron beams.

47. The device as recited in claim 45 further comprising a splitter for splitting one electron beam of the electron source and/or wherein the at least one electron source includes a plurality of electron sources.

48. The device as recited in claim 45 wherein the component is a turbine or compressor component.
